(19) United States
(12) Patent Application Publication
(10) Pub. No.: US 2007/0168115 A1
(43) Pub. Date: Jul. 19, 2007

(54) Information Output Control Method for Car-Mounted Terminal Device, Its Program and the Car-Mounted Terminal Device

(76) Inventors: Kiyoshi Ikehara, Yokohama (JP); Yoshiaki Morimoto, Kawasaki (JP); Akira Ioku, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/619,683

(22) Filed: Jan. 4, 2007

(30) Foreign Application Priority Data
Jan. 4, 2006 (JP) 2006-000161

(51) Int. Cl. G01C 21/00; G01C 21/32

(52) U.S. Cl. 701/200; 701/211; 340/995.1

(57) ABSTRACT

In a car-mounted terminal device 1 including a virtual machine 101 requesting output of first information and a navigation portion 115 requesting output of second information, a first index representing an information quantity of first information is created and a timing for outputting the first information is planned on the basis of the first index so created. A second index representing an information quantity of second information is created and a timing for outputting the first information or the second information is planned on the basis of the first index and the second index.

### INCORPORATION BY REFERENCE

This application claims priority from Japanese Patent Application JP 2006-000161, filed on Jan. 04, 2006, the content of which is hereby incorporated by reference into this application.

### BACKGROUND OF THE INVENTION

This invention relates to an information output control method, and to a program for the method, of a car-mounted terminal device that provides a navigation function and functions other than the navigation function. More particularly, the invention relates to a technology for appropriately controlling an output timing of information provided by the navigation function and information provided by functions other than the navigation function.

In car-mounted terminal devices in general that provide the navigation function such as a car navigation system, guide information needs to be outputted at an appropriate timing that does not impede driving of a driver. As one of the technologies for providing the guide information at the appropriate timing, JP-A-10-104003, for example, describes that necessary information can be accurately provided without the excessive supply of information by selecting applicant information in accordance with a predetermined priority in a navigation device. On the other hand, JP-A-2002-156241 teaches to bring speech guide into a standby state for a predetermined time on the basis of guide non-required information when a speech of a user is detected in a navigation device and not to impede the conversation of the user.

### SUMMARY OF THE INVENTION

Car-mounted terminal devices of a recent model have various functions such as the Internet connection function besides the basic function as a navigation device.

However, such car-mounted terminal devices must have a contrivance that provides at an appropriate timing the information from the navigation device and the information from other functions to the driver.

With the background described above, the invention relates to an information output control method capable of appropriately controlling an output timing of information provided by a navigation function and information provided by other functions, and a program for the method.

To accomplish the object described above, it is a main object of the invention to provide an information output control method for a car-mounted terminal device including a virtual machine requesting output of first information and a navigation portion requesting output of second information, wherein the car-mounted terminal device includes the steps of generating a first index representing an information quantity of the first information and planning a timing for outputting the first information on the basis of the first index.

In the car-mounted terminal device in which the output request of the first information based on other functions and the output request of the second information as the guide information outputted from the navigation portion are generated, the invention can plan the output timing of the first information on the basis of the first index about the first information. Consequently, the invention can provide the information at an appropriate timing to a driver.

Incidentally, the navigation device described in JP-A-10-104003 is based on the assumption that meta-information is added to information so as to select information. Because such a kind of information is not always added in advance to ordinary application software, however, the output control by means of the meta-information is not always effective. Though this patent document describes to specify a minimum value of output intervals of the information, optimal control is difficult to achieve by this means alone. In the case of application software so designed as to output the information with a short time interval, unintentional operations may occur.

The technology described in JP-A-2002-156241 basically relates to competition between the output of the navigation device and speech of the user or the operating condition but does not specifically mention control of the competition between ordinary application software and the navigation device.

According to the invention, it is now possible to appropriately control the output timing of the information provided by the navigation function and the information provided by other functions.

Other objects, features and advantages of the invention will become apparent from the following description of the embodiments of the invention taken in conjunction with the accompanying drawings.

### BRIEF DESCRIPTION OF THE DRAWINGS

FIG. 1A is a view showing hardware construction of a car-mounted terminal device 1 explained as an embodiment of the invention;

FIG. 1B is a view useful for explaining functions of the hardware construction of the car-mounted terminal device 1 explained as an embodiment of the invention;

FIG. 2 is a view showing an example of a guide plan explained as one embodiment of the invention;

FIG. 3 is a view showing an example of character index database 103 explained as one embodiment of the invention;

FIG. 4 is a flowchart useful for explaining an output control processing executed by a virtual machine output control portion 102 explained as one embodiment of the invention;

FIG. 5 is a graph showing a time change of a character index when a route guide plan portion 112 outputs the guide plan shown in FIG. 2, explained as one embodiment of the invention;

FIG. 6 is a graph showing a time change of a cumulative character index corresponding to the graph 303 shown in FIG. 5 explained as one embodiment of the invention;

FIG. 7 is a graph showing the cumulative character index of only an output request of first information explained as one embodiment of the invention;

FIG. 8 is a graph when the cumulative character index shown in a graph 313 of FIG. 6 is added to a graph 314 shown in FIG. 7 explained as one embodiment of the invention;

FIG. 9 is a graph showing a cumulative character index explained as one embodiment of the invention;

FIG. 10 is a graph when the cumulative character index shown in the graph 313 of FIG. 6 is added to a graph 316 shown in FIG. 7 explained as one embodiment of the invention;

FIG. 11A is a flowchart useful for explaining an output control processing executed by the virtual machine output control portion 102 explained as one embodiment of the invention;

FIGS. 11B to 11G are graphs each showing a time change of the cumulative character index explained one embodiment of the invention;

FIG. 12 is a view showing an example of a guide plan explained as one embodiment of the invention;

FIG. 13 is a view showing an example of an output plan of a virtual machine explained as one embodiment of the invention;

FIG. 14 is a view showing an overall output plan when the guide plan shown in FIG. 12 is combined with the virtual machine output plan shown in FIG. 13 explained as one embodiment of the invention;

FIG. 15 is a graph showing the cumulative character index of the overall output plan shown in FIG. 14 explained as one embodiment of the invention;

FIG. 16 is a graph acquired by adding a graph 324 to a graph 323 explained as one embodiment of the invention;

FIG. 17 is a graph acquired by adding a graph 325 to the graph 323 explained as one embodiment of the invention;

FIG. 18 is a sequence diagram showing a report of an output delay event explained as one embodiment of the invention;

FIG. 19 is a sequence diagram for explaining reports of an output start event and of an output completion event explained as one embodiment of the invention; and

FIG. 20 is a sequence diagram for explaining a processing of a report of an output plan updating event explained as one embodiment of the invention.

### DESCRIPTION OF THE EMBODIMENTS

Several embodiments of the invention will be hereinafter explained with reference to the accompanying drawings.

### First Embodiment

Device Construction:

A car-mounted terminal device 1 explained in the first embodiment provides a so-called “navigation function” that detects a present position of a car by utilizing GPS (Global Positioning Systems) and outputs guide information such as the present position of the car to a display device such as a display by superposing the guide information with map information stored in a recording medium such as a hard disc or DVD (Digital Versatile Disc). The car-mounted terminal device 1 has a variety of additional functions such as an audio-visual function of reproducing speech such as radio sound or images recorded to recording media such as CD/DVD, a connection function with the Internet, and so forth.

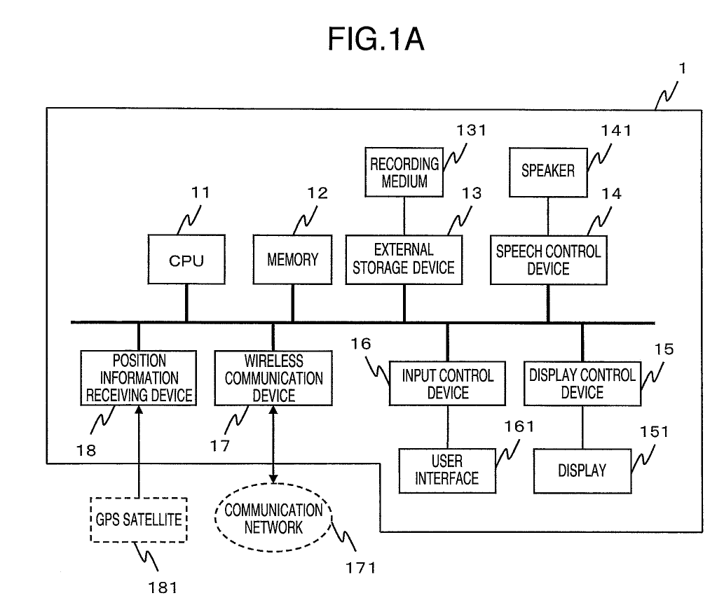

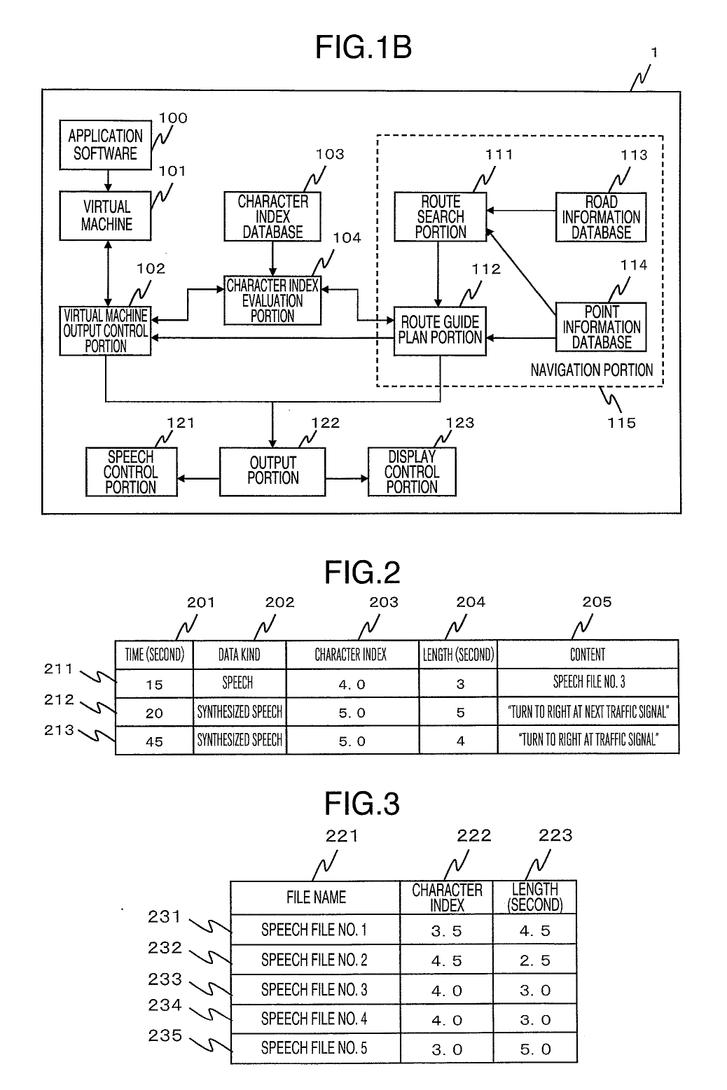

FIG. 1A shows hardware construction of the car-mounted terminal device 1. A CPU 11 governs collective processing in the car-mounted terminal device 1 and executes software for realizing the functions provided by the car-mounted terminal device 1. A memory 12 such as RAM/ROM stores programs and data executed by the CPU 11. An external storage device 13 is the one that executes data read/write from and to a recording medium 131 such as a hard disc and DVD/CD. Incidentally, the storage medium 131 stores various programs and data such as a program for realizing an operation system and application software 100, audio and speech data used for map information and speech guide, and so forth.

A sound control device 14 controls a sound outputted to a speaker 141. A display control device 15 outputs an image to a display 151. An input control device 16 accepts a user's operation input made to a user interface 161 such as operation buttons, a touch panel and a remote controller. A wireless communication device 17 provides the function of connection with a communication network 171 such as a packet network that is connected to a mobile telephone network and the Internet. A position information reception device 18 receives position information transmitted from GPS satellites 181.

FIG. 1B shows the hardware of the car-mounted terminal device 1 or the functions of the car-mounted terminal device 1 realized when the CPU 11 executes the programs stored in the memory 12 or in the recording medium 12. A virtual machine 101 that is shown in the drawing outputs an output request of information (hereinafter called “first information”) to a virtual machine output control portion 102 in response to a request sent from application software 100. Java (registered trade mark) VM is one of the examples of the virtual machines having such functions. Incidentally, the first information is text data or speech data as the basis of the synthesized speech and character display on a window, for example, and is the information capable of calculating the indices and the time length representing either correctly or approximately at least the number of characters. The virtual machine output control portion 102 outputs the first information to a character index evaluation portion 104, too.

The character index evaluation portion 104 creates a character index as a value representing an information quantity of the first information on the basis of the inputted first information and outputs the character index so created to the virtual machine output control portion 102.

The virtual machine output control portion 102 controls the output of the first information to an output portion 122 on the basis of the character index inputted from the character index evaluation portion 104 and of the guide plan inputted from the route guide plan portion 112.

The character index database 103 stores those indices such as constants which are looked up when the character index is calculated on the basis of the first information or the second information. The character index database 103 stores the index for each kind of information.

The first information outputted from the virtual machine output control portion 102 or guide information outputted from the route guide plan portion 112 (hereinafter called “second information”) is inputted to the output portion 122. The output portion 122 outputs the first information inputted or the speech based on each information in accordance with the kind of the guide information to the speech control portion 121 or the images based on the respective information to the display control portion 123.

The kind of the guide information includes guide information provided by the speech of a speech data format system (hereinafter called “direct speech”), guide information provided by synthesizing the speech on the basis of the text data (hereinafter called “synthesized speech”) and guide information provided by the images (hereinafter called “image”).

The speech control portion 121 controls the speech control device 14 and outputs the speech inputted from the output portion 122 to the speaker 141. The display control portion 123 controls the display control portion 15 and outputs the image inputted from the output portion 122 to the display 151.

A navigation portion 155 that provides a function relating to navigation includes a route search portion 111, a route guide plan portion 112, a road information database 113 and a point information database 114.

Among them, the route search portion 111 executes the route search by utilizing the map information (road information) stored in road information database 113 and point information stored in the point information database 114, and outputs the search result to the route guide plan portion 112.

The route guide plan portion 112 creates a guide plan on the basis of the result of the road search carried out by the route search portion 111 and outputs the guide information to the output portion 122 on the basis of the guide plan so created. The route guide plan portion 112 outputs a guide plan illustrating the list of the information outputted by the route guide plan portion 112 to the virtual machine output control portion 102. Incidentally, the output of the guide plan by the route guide plan portion 112 is conducted independently of the operations of the virtual machine 101 and of the virtual machine output control portion 102.

FIG. 2 shows an example of the guide plan. In the drawing, a time representing the output timing of the guide information is set to a column 201 of the time. The data kind of the guide information (“speech”, “synthesized speech”, “images”, etc) is set to a column 202 of the data kind. A character index of the guide information is set to a column 203 of the character index. The time required for outputting the guide information is set to a column 204 of length. Information representing the content of the guide information is set to a column 205 of the content. Incidentally, the column of the content is added for the sake of convenience of explanation and need not always be outputted from the virtual machine output control portion 102.

Explanation of Processing:

Next, the character index calculation processing executed by the character index evaluation portion 104 will be explained. The character index evaluation portion 104 calculates the character indices for the first information inputted from the virtual machine output control portion and the guide information inputted from the route guide plan portion 112.

First, the calculation method of the character index about the guide information classified into the data kind “synthesized speech” will be explained by way of example. In this case, the character index evaluation portion 104 calculates the character index by dividing the number of characters contained in the text data as the basis of the speech synthesis by the time necessary for reproducing the speech after the synthesis. When the text data as the basis is 10-character data of “ME I RU GA TO DO KI MA SHI TA” and the length is 2 seconds as a result of the speech synthesis, the character index about this guide information is character number/length=10/2=5.0.

When the data kind is “speech”, the character index evaluation portion 104 calculates the character index by looking up the character index database 103. FIG. 3 shows an example of the character index database 103. In the drawing, a file name of speech data corresponding to the guide information is set to a column 221 of the file name. The character index is set to a column 222 of the character index and the time required for outputting the guide information is set to a column 223 of the length.

To calculate the character index, the character index evaluation portion 104 first searches the file name coincident with the file name of the speech data corresponding to the guide information from the column 221 of the fine name of the character index database 103 and acquires the character index and the length. When the file name is “speech file No. 3”, for example, it is coincident with symbol 233 of the character index database 103. Therefore, the character index evaluation portion 104 acquires “4.0” as the character index and “3.0” as the length. Incidentally, when the file name coincident with the file name of the speech data does not exist in the character index database 103, the navigation portion 115 acquires the character index of the default that is set in advance, and the length contained in the header information of the file.

On the other hand, calculation of the character index about the first information inputted from the virtual machine output control portion 102 uses, as the character index, the value obtained by dividing the accompanying character number by the reproduction time when the first information is given as the speech and the character number is attached as meta-data to the first information. When the meta-data is not attached to the first information, a predetermined value is used as the character index.

The number of characters outputted in the unit time is hereby used as the character index but various others can be used, too. For example, the number of words outputted in the unit time or the number of phonemes outputted in the unit time may be used as the character index.

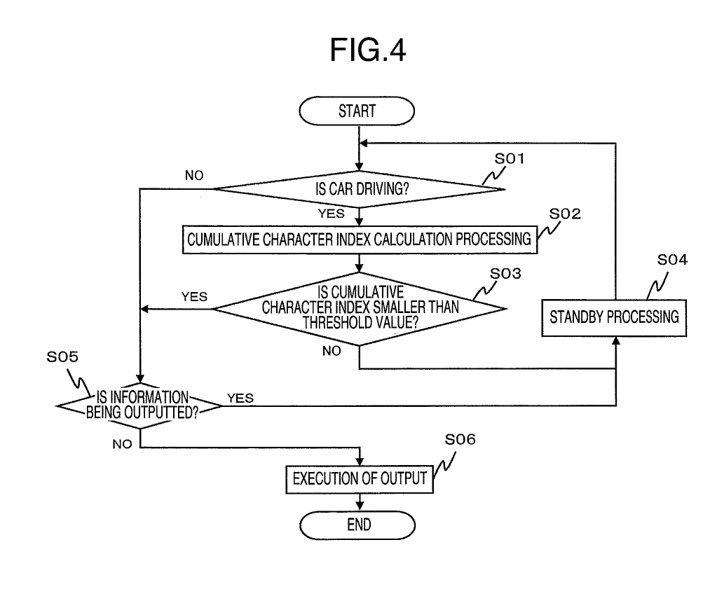

Next, the output control processing executed by the virtual machine output control portion 102 will be explained with reference to the flowchart of FIG. 4. In the explanation that follows, character “S” put to the start of symbols represents a processing step.

When the output request of the first information is inputted from the virtual machine 101, the virtual machine output control portion 102 judges whether or not the car is running (S01). When the car is running (S01: YES), the flow proceeds to the processing of S02. When the car is not running (S01: NO), the flow proceeds to S05.

In S02, the virtual machine output control portion 102 executes a cumulative character index calculation processing to calculate a cumulative character index. The detail of this cumulative character index calculation processing will be later described.

In subsequent S03, the virtual machine output control portion 102 judges whether or not the cumulative character index determined at each time determined in S02 is smaller than a predetermined threshold value (S03). When the cumulative character index at each time is smaller than the threshold value (S03: YES), the flow proceeds to S05. When the cumulative character index at each time is greater than the threshold value (S03: NO), the flow proceeds to S04.

In S05, when the output portion 122 is outputting the information (S05: YES), the flow proceeds to S04. When the output portion 122 is not outputting the information (S05: NO), the flow proceeds to S06. In S04, the virtual machine output control portion 102 waits for a predetermined time. After waiting, the flow returns to S01. In S06, the virtual machine output control portion 102 outputs the information to the output portion 122.

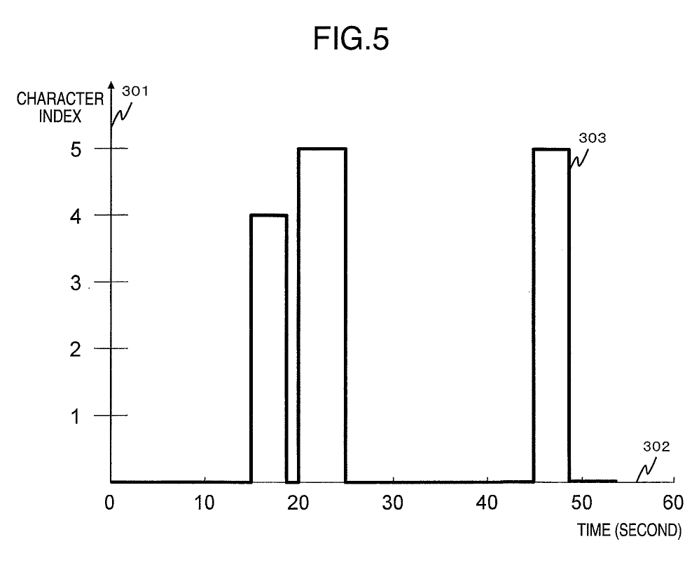

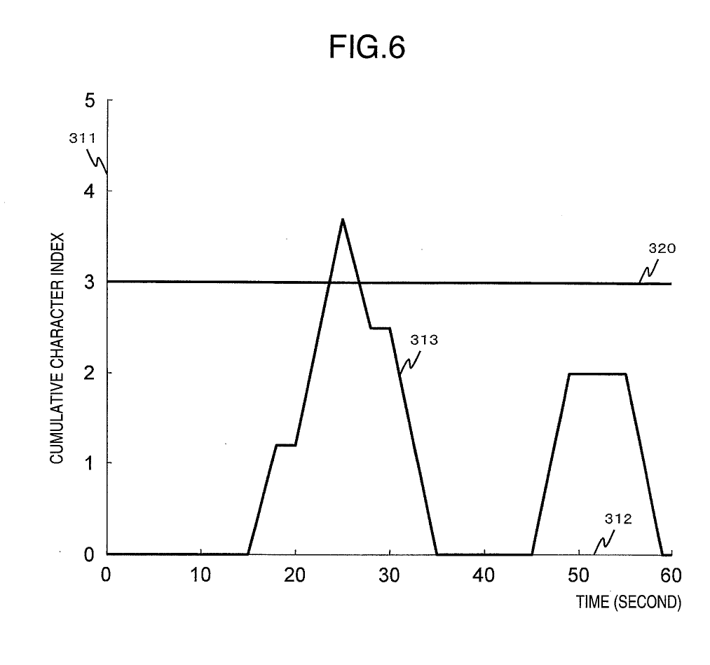

Next, the cumulative character index calculation processing in S02 and the judgment processing in S03 will be explained in detail with reference to FIGS. 5 and 6.

FIG. 5 shows by graph the time change of the sum of the character indices when the route guide plan portion 112 outputs the guide plan shown in FIG. 2. In the graph, ordinate 301 represents the sum of the character indices and abscissa 302 represents the time. FIG. 6 shows by graph the time change of the cumulative character index corresponding to the graph 303 shown in FIG. 5. Ordinate 311 represents the cumulative character index and abscissa 312 represents the time. Straight line 320 in the graph represents the threshold value (3.0) used for the judgment processing of S03.

The virtual machine output control portion 102 determines the sum of the character indices at the time t by summing the values of the column 203 of the character index of the row satisfying the condition that the time t is greater than the value of column 201 of the time in FIG. 2 and is smaller than the sum of the column 201 of the time and the column 204 of the length. When the time t is 47 (seconds), for example, the character index in this case is the value 5.0 of the column 203 of the character index represented by reference numeral 213 because it is the sum of the values of the column 203 of the row of the character indices in FIG. 2.

The virtual machine output control portion 102 calculates the cumulative character index on the basis of the character index determined in this way. For example, the virtual machine output control portion 102 the cumulative character index at a certain time t as a value obtained by dividing the total of the character indices outputted in the past for a predetermined time T with the time t being the reference (integration value of character indices in zone [t−T, t]) by T. When T=10 (seconds), for example, the cumulative character index at the time t=47 (seconds) in FIG. 6 is 1.0 by dividing the integration value 10 of the character indices in the zone [37, 47] on the abscissa 302 in FIG. 55 by the length of this zone 10 (seconds).

Incidentally, the virtual machine output control portion 102 determines the cumulative character index about the inputted guide plan whenever the guide plan is inputted from the route guide plan portion 112. When the output of the first information is requested from the virtual machine 101, the virtual machine output control portion 102 calculates the cumulative character index at each time by the requested output alone. The virtual machine output control portion 102 adds the calculated cumulative character index at each time to the position at the same time of the cumulative character index of the guide plan determined in advance. In the following explanation, the zone in which the cumulative character index is not 0 will be called “influence zone”.

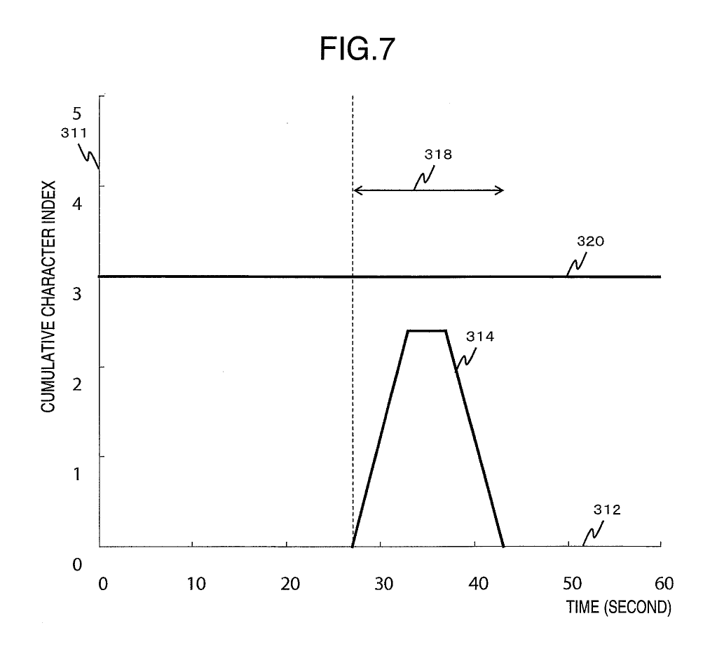

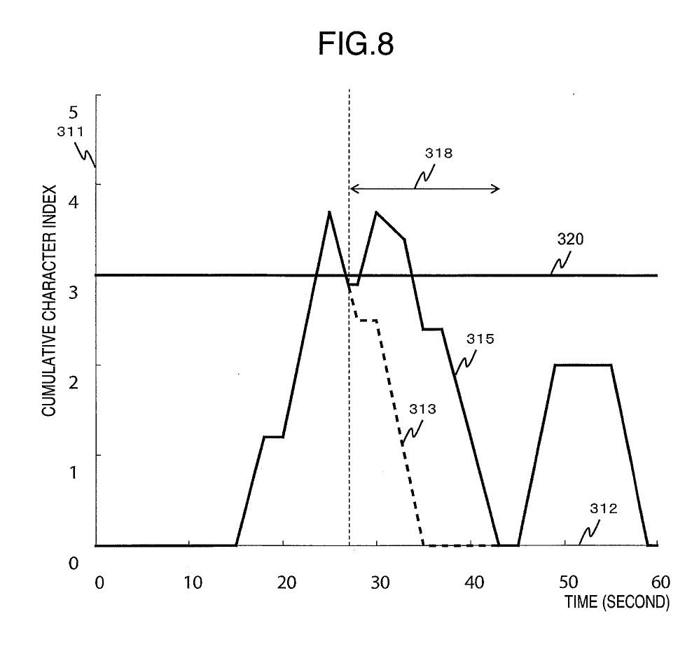

In S03, whether or not the cumulative character index determined in this way exceeds the threshold value determined in advance in the influence zone of the output of the first information is judged. It will be assumed hereby that the output request of the first information of the character index 4.0 and the length 6.0 seconds is requested by the virtual machine 101 at the time t=27 (seconds). The graph 314 shown in FIG. 7 can be obtained when the cumulative character index of the output request of the first information alone is expressed by graph. The graph 315 shown in FIG. 8 can be obtained when the cumulative character index shown by the graph 313 in FIG. 6 is added to the graph 314 shown in FIG. 7. Since the cumulative character index is greater than the threshold value (3.0) in this case in the influence zone 318 as shown in FIG. 8, the processing shifts to the standby processing of S04.

In the standby processing of S04, the virtual machine output control portion 102 keeps the standby state for a predetermined time and then proceeds to S01. It will be assumed hereby that the judgment of S03 is again made at the time t=30 (seconds) after the shift to S01.

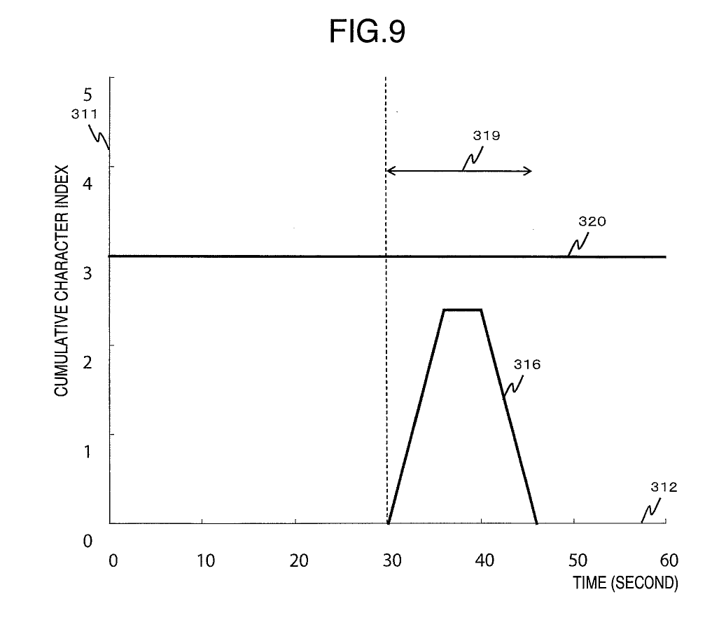

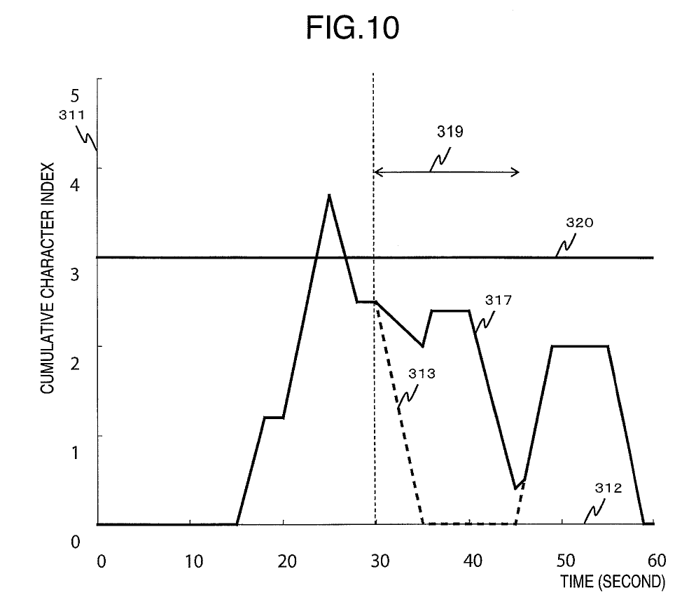

The graph 316 in FIG. 9 represents by graph the cumulative character index at this time. When the cumulative character index represented by the graph 313 of FIG. 6 is added to this graph 316, the graph 317 shown in FIG. 10 can be acquired. Here, the character index does not exceed the threshold value 320 (3.0) in the influence zone 319 and the flow proceeds to S05 as the result of judgment of S03.

Incidentally, the threshold value 320 is set to a suitable value in accordance with the driving condition at that point of time. For example, the threshold value 320 may well be changed in accordance with the driving speed of the car to which the car-mounted terminal device 1 is mounted. As the threshold value 320 is changed in this way, appropriate information can be given to the driver in accordance with the driving condition.

In the car-mounted terminal device 1 that generates the output request of the first information and the output request of the second information as the guide information outputted from the navigation portion 115, the car-mounted terminal device 1 according to the invention can make a plan of the timing for outputting the first information on the basis of the first index about the first information and the second index about the second information. Therefore, the car-mounted terminal device of the invention can provide the information to the driver at the suitable timing.

### Second Embodiment

Next, the second embodiment of the invention will be explained. The apparatus construction of the car-mounted terminal device 1 to be explained as the second embodiment is the same as the apparatus construction of the first embodiment. When the cumulative character index exceeds the threshold value, the car-mounted terminal device 1 according to the second embodiment further executes a re-evaluation processing of the cumulative character index after the outputting method of the first information is changed in addition to the processing executed by the virtual machine output control portion 102 in the first embodiment.

FIG. 1A is a flowchart useful for explaining the output control processing executed by the virtual machine output control portion 102 in the car-mounted terminal device 1 explained as the second embodiment.

When the output request of the first information is inputted from the virtual machine 101, the virtual machine output control portion 102 judges whether or not the car is under the driving condition (S11). When it is under the driving condition (S11: YES), the flow proceeds to the processing of S12. When it is not under the driving condition (S11: NO), the flow proceeds to the processing of S15.

In S12, the virtual machine output control portion 102 calculates the cumulative character index by the processing similar to that of S02 in FIG. 3 and determines the cumulative character index at each time in the case where the output is assumed to be made at the present time.

In the subsequent processing of S13, the virtual machine output control portion 102 judges whether or not the cumulative character index at each time determined in S12 is smaller than a predetermined threshold value. When the cumulative character index is below the threshold value (S13: YES), the flow proceeds to S15. The flow proceeds to S17 when the cumulative character index exceeds the threshold value (S13: NO).

In S17, the virtual machine output control portion 102 judges whether or not the first information the output request of which is made is data capable of adjusting an output speed (hereinafter called “adjustable data”). This judgment is made on the basis of the data kind of the first information, for example. It will be assumed hereby that the virtual machine output control portion 102 judges that the first information is the adjustable data when the data kind is “synthesized speech”.

When the first information is the adjustable data (S17: YES), the flow proceeds to S18. When it is not the adjustable data (S17: NO), the flow proceeds to S14.

In S14, the virtual machine output control portion 102 waits for the end of the output when the output portion 122 is conducting the output to meet with other output request (S14: YES). When the output portion 122 is not outputting (S14: NO), the virtual machine output control portion 102 keeps the standby state for a predetermined time (S20) and the flow then shifts to S11.

In S18, the virtual machine output control portion 102 adjusts the output speed for the first information. When the data kind is “synthesized speech”, the text to be read is summarized to shorten its length or the speech speed is lowered as means for adjusting the output speed. Other methods for adjusting the speed will be later described.

After executing the adjustment processing of the first information, the virtual machine output control portion 102 executes the processing similar to that of S12 for the first information after the adjustment and again calculates the cumulative character index at the present time. The flow then proceeds to S19.

In S19, the virtual machine output control portion 102 judges whether or not the cumulative character index determined in S18 is smaller than the predetermined threshold value. When the cumulative character index is smaller than the threshold value (S19: YES), the flow shifts to S15. When the cumulative character index exceeds the threshold value (S19: NO), the flow proceeds to S14.

In S15, the virtual machine output control portion 102 judges whether or not the output portion 122 is outputting the output to meet with other output request. When the output portion 122 is outputting (S15: YES), the flow proceeds to S14. When the output portion 122 is not outputting, the flow proceeds to S16.

In S16, the virtual machine output control portion 102 outputs the first information to the output portion 122.

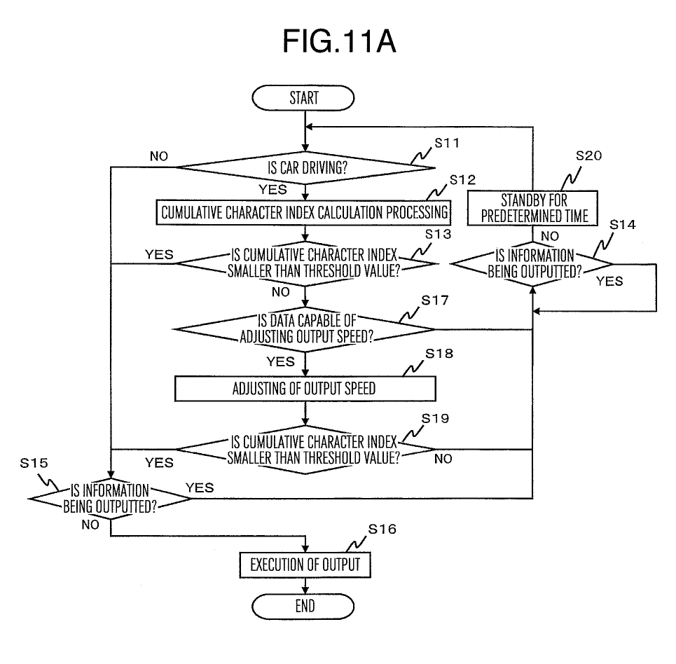

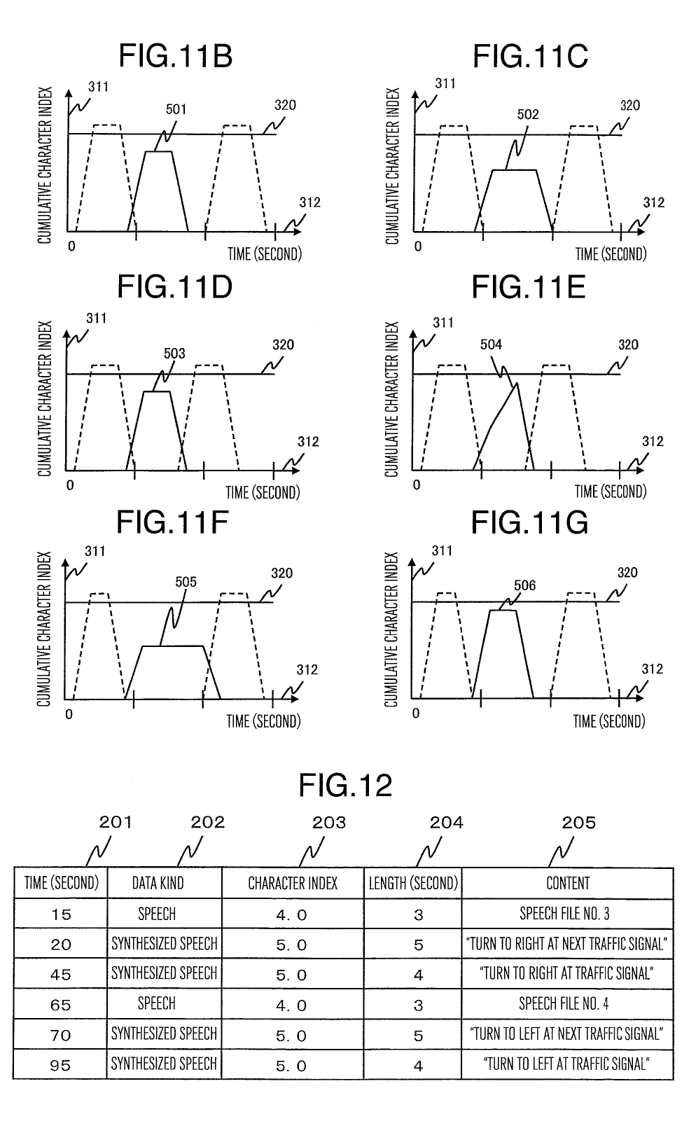

Next, a concrete example of the output speed adjustment processing in S18 will be explained with reference to FIGS. 11B to 11G. FIGS. 11B to 11G each represents the time changes of the cumulative character index.

The graph 501 in FIG. 11B, the graph 503 in FIG. 11D and the graph 505 in FIG. 11F represent the cumulative character index about the first information the output request of which is made. The graph 502 in FIG. 11C, the graph 504 in FIG. 11E and the graph 506 in FIG. 11G represent the time change of the cumulative character index for the graph 501 in FIG. 11B, the graph 503 in FIG. 11D and the graph 505 in FIG. 11F, respectively, when the output speed is adjusted.

First, the graph 501 in FIG. 11B represents the case where the sum of the cumulative character index with the information outputted just before exceeds the threshold value 320. In this case, the output speed of the first information is adjusted so that the output time gets elongated as represented by the graph 502 in FIG. 11C and the cumulative character index can be outputted without exceeding the threshold value 320. In the case of the synthesized speech, the speech speed of the first informally may well be lowered, for example.

The graph 503 in FIG. 11D represents the case where the sum of the cumulative character index with the information outputted just before exceeds the threshold value 320 in the same way as in the case of the graph 501. However, since the subsequent output is planned immediately after, the output time cannot be set to a long time. In such a case, the information output is slowly made at first and is then sped up gradually as represented by the graph 504 in FIG. 11E. In the case of the synthesized speech, the speech is divided into each speech character, for example, and the speech speed of the individual speech divided is increased with the lapse of time.

The graph 505 in FIG. 11F represents the case where the sum of the cumulative character index with the subsequent output exceeds the threshold value. In such a case, the output can be made in some cases by shortening the output time. In the case of the synthesized speech, the speech speed may be increased for example.

Incidentally, decision of the output speed of the first information may be set within a predetermined range having the threshold value 320 to be judged in S13 or S17 as its upper limit or may use a value which is set for each case.

As described above, in the car-mounted terminal device 1 according to the invention, when the output of the first information is not judged as being possible, the output method of the first information is changed and whether or not the first information can be outputted is judged again. Therefore, the first information can be outputted at the time approximate to the time at which the output of the virtual machine 101 is originally scheduled.

### Third Embodiment

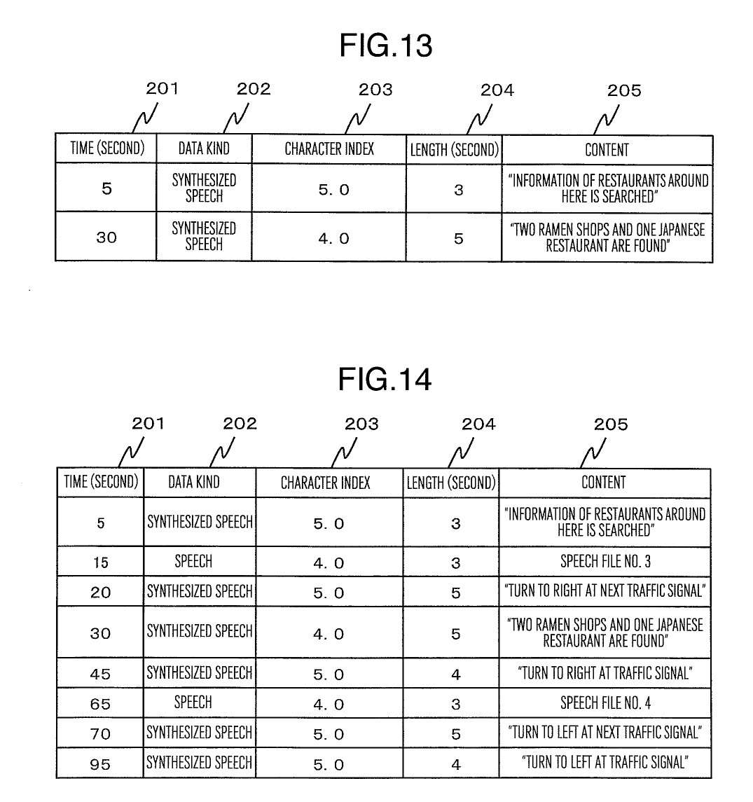

Next, the third embodiment of the invention will be explained. The apparatus construction of the car-mounted terminal device 1 to be explained as the third embodiment is the same as the apparatus construction of the car-mounted terminal device 1 of the first embodiment. In the car-mounted terminal device according to the third embodiment, the virtual machine output control portion 102 creates the output plan (an example of which is shown in FIG. 13) of the virtual machine as a list of first information to be outputted from the virtual machine 101, and outputs the first information independently of the operation of the virtual machine 101. In other words, the virtual machine output control portion 102 stores the output plan of the virtual machine and the virtual machine output control portion 102 executes the output to the output portion in accordance with this output plan.

The car-mounted terminal device 1 explained as the third embodiment executes a virtual machine output re-plan processing and a virtual machine output plan processing. In the former, that is, the virtual machine output re-plan processing, the output plan of the virtual machine is updated at the point of time at which the route guide plan portion 112 gives the guide plan to the virtual machine output control portion 102. All those rows in the output plan of the virtual machine in which the output of the first information is not executed at present are extracted and the virtual machine output plan processing to be explained next is again applied serially to them from the older output plans to update the output plan of the virtual machine. In the latter, that is, the virtual machine output plan processing, the output of the first information is planned at the time at which the output is judged as possible when the output request of the first information is requested from the virtual machine 101 to the virtual machine output control portion 102. The virtual machine output plan processing will be hereinafter explained concretely.

First, when the output request of the first information is inputted from the virtual machine 101 to the virtual machine output control portion 102, the virtual machine output control portion 102 searches the time at which the requested first information can be outputted, by looking up the guide plan given from the route guide plan portion 112 and the output plan of the virtual machine. The virtual machine output control portion 102 then updates the output plan of the virtual machine so that the first information the output of which is requested can be outputted.

The search of the time capable of outputting is made by, for example, comparing the output time of the first information which is scheduled to be outputted lastly with the present time, setting the latter time as the initial time and linearly searching the time in the increasing direction of the time with the initial time being as the starting point. As the processing similar to the cumulative character index calculation processing in S02 shown in FIG. 4 is executed, the cumulative character index when the influence zone of the first information for which output request is made, and the first information for which output request is made are inserted into the output plan of the virtual machine is determined and judgment is then made as to whether or not the output of the first information for which output request is made can be outputted, by the processing similar to the judgment processing of S03 in FIG. 4.

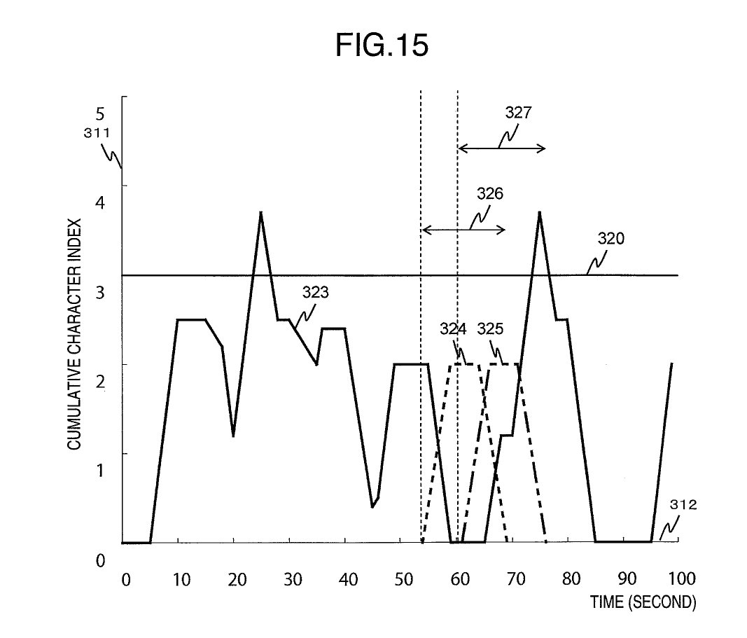

It will be assumed hereby that the guide plan has the content shown in FIG. 12 and the output plan of the virtual machine has the content shown in FIG. 13, and that the output of the synthesized speech (character index 4.0, output time 5.0 (seconds)) is requested from the virtual machine 101 to the virtual machine control portion 102 at the time 20 (seconds). In this case, the overall output plan prepared by combining the guide plan shown in FIG. 12 with the virtual machine output plan shown in FIG. 13 is the one that is shown in FIG. 14. The graph 32 in FIG. 15 represents the graph of the cumulative character index in this case. In FIG. 15, straight line 320 represents the threshold value and zones 326 ad 327 are influence zones.

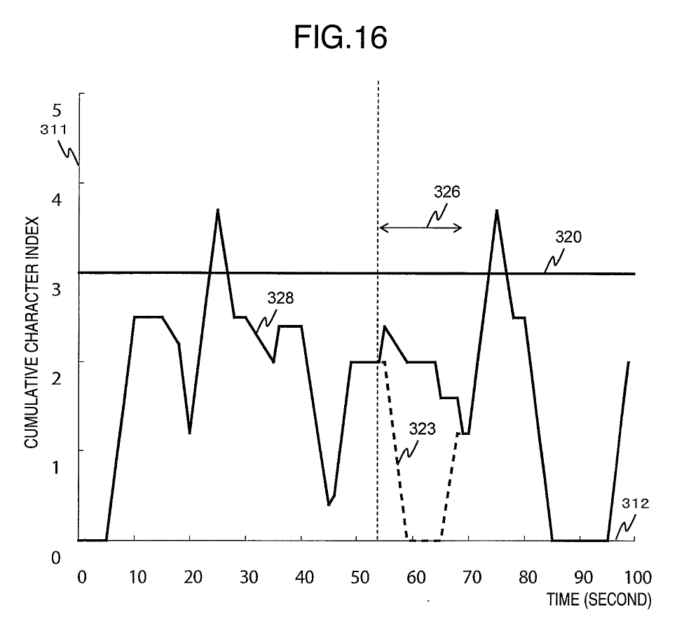

Graph 324 of dash line represents the cumulative character index corresponding to the first information by the synthesized speech at the time 54 (seconds), for example. When this graph 324 is added to the graph 323, graph 328 shown in FIG. 16 can be obtained. As shown in FIG. 16, the cumulative character index does not exceed the threshold value in the influence zone 326 even when the graph 324 is added as shown in FIG. 16. Therefore, planning of the output of the first information at this time by the speech synthesis is judged as being possible.

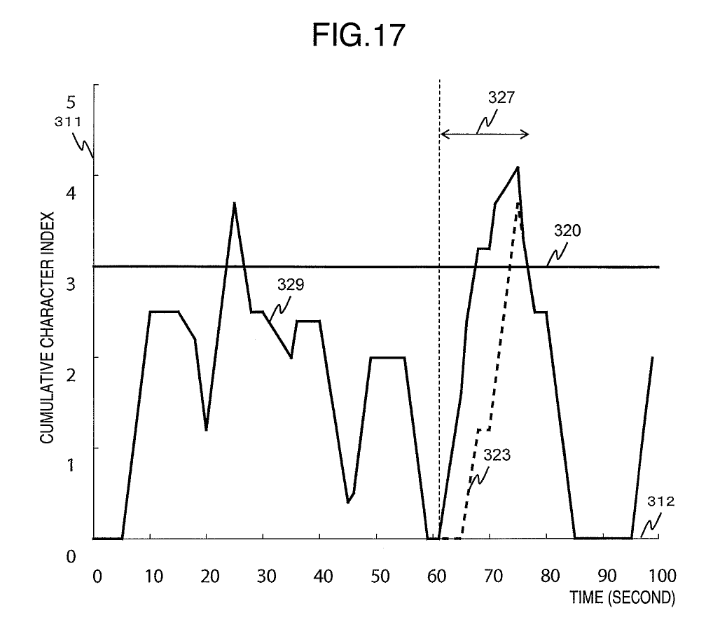

In FIG. 15, graph 325 of dash line represents the cumulative character index corresponding to the output of the first information by the speech synthesis at the point of time 61 (seconds), for example. Graph 329 shown in FIG. 17 can be obtained by adding the graph 325 to the graph 323. In this case, the cumulative character index exceeds the threshold value if the graph 324 is added in the influence zone 327. Therefore, planning of the output of the first information at this time by speech synthesis is judged as being impossible.

Incidentally, when a plurality of times at which planning of the output of the first information is possible exists, planning is made at the latest time (time 54 (seconds) in the example given above) among the times at which planning can be made.

As described above, in the car-mounted terminal device 1 according to the invention, the overall output plan is created on the basis of the output plan of the first information and the output plan of the second information and the time for outputting the first information or the second information is planned lest the cumulative value exceeds the predetermined threshold value. Consequently, the output of the information can be smoothly carried out without inviting the concentration of the processing. In addition, competition between the output of the virtual machine and the output of the navigation portion 115 can be avoided in advance.

### Fourth Embodiment

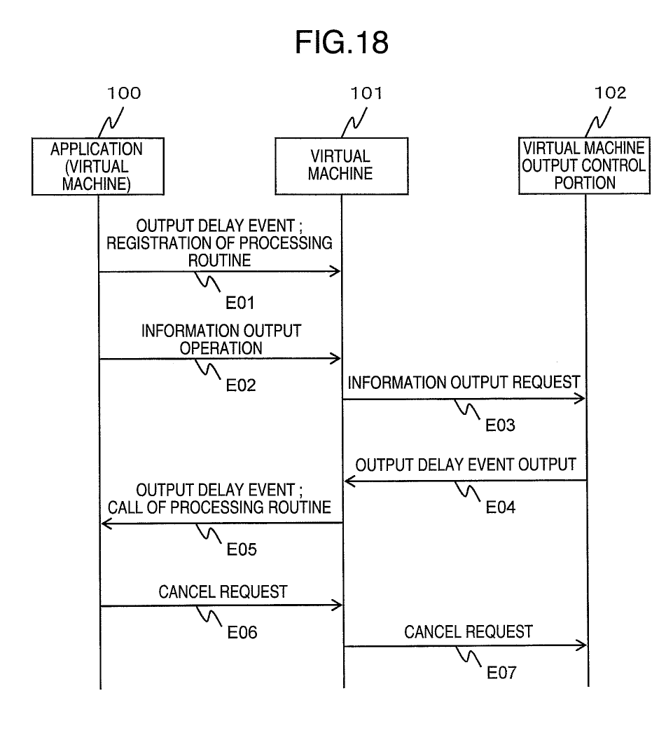

Next, the fourth embodiment will be explained. The apparatus construction of the car-mounted terminal device 1 explained as the fourth embodiment is the same as the apparatus construction of the car-mounted terminal device 1 of the first embodiment. In the car-mounted terminal device 1 of the fourth embodiment, the virtual machine control portion 102 reports an output delay event to the virtual machine 101 in S04 in FIG. 4. The processing about the notice of the output delay event will be hereinafter explained with a sequence diagram for explaining the output delay event notice processing shown in FIG. 18.

First, the application software 100 registers a processing routine of the output delay event to the virtual machine 101 (E01). Next, when the application software 100 executes the information output operation (E02), the virtual machine 101 outputs the output request of the first information to the virtual machine output control portion 102 (E03). When the output request of the first information is inputted, the virtual machine output control portion 102 executes the output control processing shown in FIG. 4. When the standby processing of S04 in FIG. 4 is executed, the virtual machine output control portion 402 outputs the output delay event to the virtual machine 101 (E04).

The virtual machine 101 executes the program of the output delay event registered in E01 when the output delay event is inputted (E05).

Here, the application software 100 judges whether or not the output of the first information is necessary and when judging that the output is not necessary, outputs a cancel request of the output request of the first information to the virtual machine 101 (E06). When the cancel request is inputted, the virtual machine 101 outputs the cancel request to the virtual machine output control portion 102 (E07). When the cancel request is inputted, the virtual machine output control portion 102 deletes the output processing of the first information that is delayed and queued, from the output plan of the virtual machine.

As described above, in the car-mounted terminal device 1 according to the invention, the output plan of the virtual machine is reported to the application software and the application software 100 can control whether or not the output of the first information is to be stopped. Therefore, those kinds of information which are out of date or which are no longer necessary are not outputted and appropriate information can be provided to the driver. The output load of the first information by the virtual machine 101 can be reduced.

### Fifth Embodiment

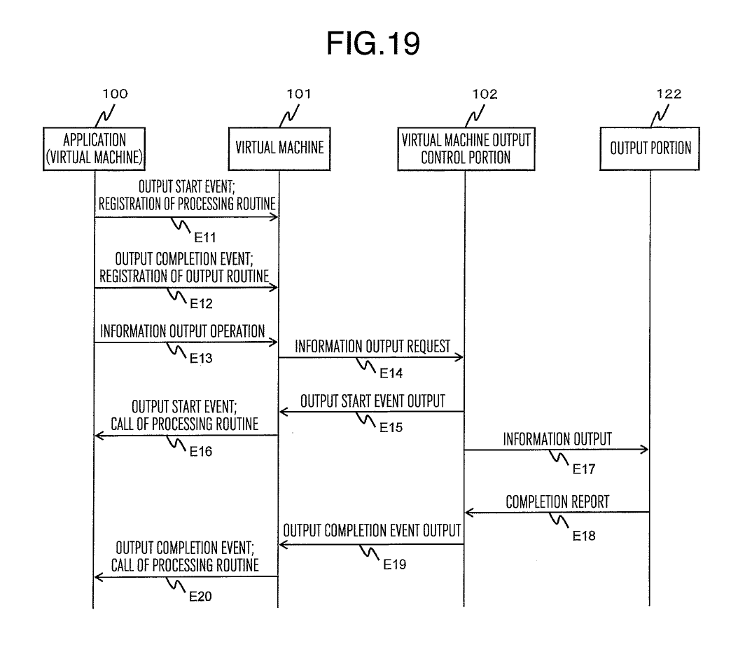

Next, the fifth embodiment will be explained. The apparatus construction of the car-mounted terminal device 1 explained to be explained as the fifth embodiment is the same as the apparatus construction of the car-mounted terminal device 1 according to the first embodiment. In the car-mounted terminal device 1 of the fourth embodiment, the virtual machine output control portion 102 reports an output start event to the virtual machine 101 in S06 in FIG. 4. The virtual machine output control portion 102 reports an output completion event to the virtual machine 101 at the point of time at which the output is completed. The processing about the output start event and the output completion even will be hereinafter explained with reference the sequence diagram of FIG. 19 that is useful for explaining the report of the output delay event.

To begin with, the application software 100 registers the processing routines of the output start event and the output completion event to the virtual machine 101 (E11, E12). Next, when the application software 100 executes the information output operation (E13), the virtual machine 101 outputs the output request of the first information to the virtual machine output control portion 102 (E14).

When the output request is inputted, the virtual machine output control portion 102 executes the processing in accordance with the flowchart shown in FIG. 4. The virtual machine output control portion 102 outputs the output start event to the virtual machine 101 when the output processing is executed in S06 in FIG. 4 (E15).

When the output start event is inputted, the virtual machine 101 executes (E16) the program of the output start event registered in (E11).

The output portion 122 outputs the output completion report (E18) to the virtual machine output control portion 102 when the output of the first information is made (E17) and the output is completed.

When the output completion report is inputted from the output portion 122 (E18), the virtual machine output control portion 102 outputs the output completion event to the virtual machine 101 (E19). When the output completion event is inputted (E12), the virtual machine 101 executes the program of the output completion event registered in (E12).

As described above, in the car-mounted terminal device 1 according to the invention, the output start event and the output completion event are reported from the virtual machine output control portion 102 to the virtual machine 101. Therefore, the virtual machine 101 can know the start of the output of the first information or completion of the output of the first information.

### Sixth Embodiment

Next, the sixth embodiment will be explained. The apparatus construction of the car-mounted terminal device 1 to be explained as the sixth embodiment is the same as the apparatus construction of the car-mounted terminal device 1 according to the first embodiment. In addition to the functions of the car-mounted terminal device 1 of the third embodiment, the virtual machine output control portion 102 of the car-mounted terminal device 1 of this embodiment reports the event to the virtual machine 101 when the output plan of the virtual machine is updated. Incidentally, the function of reporting the output start event and the output completion event of the fourth embodiment may be added to the car-mounted terminal device 1 of the sixth embodiment.

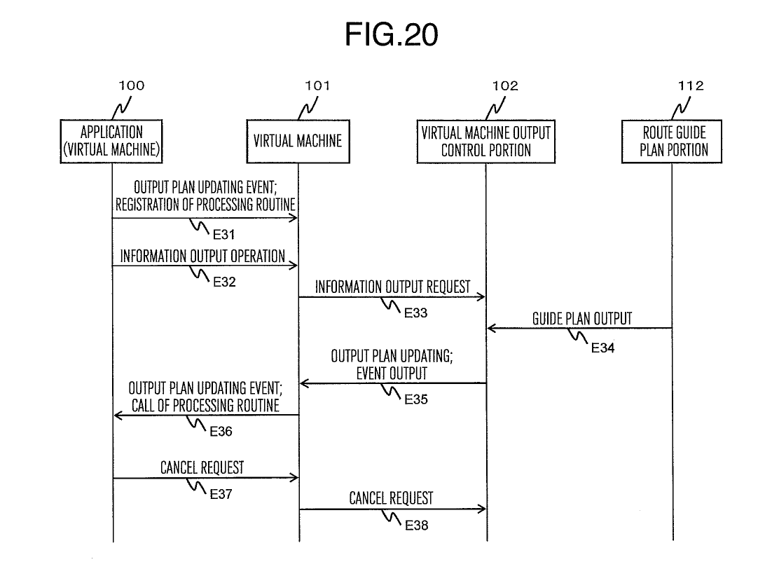

In the car-mounted terminal device 1 according to the sixth embodiment, the virtual machine output control portion 102 reports an output plan updating event to the virtual machine 101 when the guide plan is outputted from the route guide plan portion 112 of the navigation portion 155. The processing about the report of the output plan updating event will be explained with reference to the sequence diagram of FIG. 20.

To begin with, the application software 100 registers the processing routines of the output plan updating event to the virtual machine 101 (E31). Next, when the application software 100 executes the information output operation (E32), the virtual machine 101 outputs the output request of the first information to the virtual machine output control portion 102 (E33). In consequence, the virtual machine output plan processing is started.

When the guide plan is outputted from the route guide plan portion 112 (E34), the virtual machine output control portion 102 updates the output plan of the virtual machine by the virtual machine output re-plan processing and outputs the output plan updating event to the virtual machine 101 (E35).

When the output plan updating event is inputted, the virtual machine 101 executes (E36) the program of the output plan updating event registered in (E31).

Here, the application software 100 judges whether or not the output of the first information is necessary. When the output is not judged as necessary, the application software 100 outputs a cancel request of the output request of the first information to the virtual machine 101 (E37). When the cancel request is inputted, the virtual machine 101 outputs the cancel request to the virtual machine output control portion 102 (E38). When the cancel request is inputted, the virtual machine output control portion 102 deletes the output processing of the first information that is delayed and queued, from the output plan of the virtual machine. In this case, the output plan of the virtual machine may be updated by executing the virtual machine output re-plan processing.

As described above, in the car-mounted terminal device 1 of the invention, the virtual machine output control portion 102 reports the event to the virtual machine 101 when the output plan of the virtual machine is updated. The application software 100 or the virtual machine 101 executes control to cancel the output of the first information or to change the output plan. Therefore, those kinds of information which are out of date or which are no longer necessary are not outputted and appropriate information can be provided to the driver. The output load of the first information by the virtual machine 101 can be reduced.

The explanation of the foregoing embodiments is solely directed to have the invention easily understood and in no way limits the invention. Therefore, the invention can be changed or modified in various ways without departing from the scope thereof and of course embraces such equivalents within its scope.

1. An information output control method for a car-mounted terminal device including a virtual machine requesting output of first information and a navigation portion requesting output of second information, wherein a method executed by said car-mounted terminal device includes the steps of:
generating a first index representing an information quantity of said first information; and
planning a timing for outputting said first information on the basis of said first index.

2. An information output control method as defined in claim 1, wherein the method executed by said car-mounted terminal device further includes the steps of:
generating a second index representing an information quantity of said second information; and
planning a timing for outputting said first information or said second information on the basis of said first index and said second index.

3. An information output control method as defined in claim 2, wherein the method executed by said car-mounted terminal device further includes the step of:
planning a timing for outputting said first information or said second information in such a fashion that a cumulative value obtained by adding said first index and said second index outputted in the past for a predetermined time to said first index about said first information the output of which is afresh requested does not exceeds a threshold value set in advance.

4. An information output control method as defined in claim 2, wherein the method executed by said car-mounted terminal device further includes the steps of:
generating an overall output plan on the basis of the output plan of said first information by said virtual machine and the output plan of said second information inputted from said navigation portion;
calculating a cumulative value of said first index and said second index about said overall output plan; and
planning a timing for outputting said first information or said second information in such a fashion that said cumulative value does not exceed a threshold value set in advance.

5. An information output control method as defined in claim 3, wherein the method executed by said car-mounted terminal device further includes the step of:
changing said threshold value in accordance with a driving speed of a car.

6. An information output control method as defined in claim 1, wherein the method executed by said car-mounted terminal device further includes the steps of:
judging whether or not the output of said first information can be made when the timing for outputting said first information is planned; and
changing the output method of said first information and making again said judgment when the output of said first information is not judged as possible.

7. An information output control method as defined in claim 1, wherein the method executed by said car-mounted terminal device further includes the steps of:
reporting the result of said plan about the output of said first information to said virtual machine; and
canceling the output of said first information or updating said plan in accordance with the response result of said virtual machine to said report.

8. A computer program product in a car-mounted terminal device containing a program for accomplishing:
a virtual machine function requesting output of first information;
a navigation function requesting output of second information;
a function of generating a first index representing an information quantity of said first information;
a function of generating a second index representing an information quantity of said second information; and
a function of planning a timing for outputting said first information or said second information on the basis of said first index and said second index.

9. A computer program product as defined in claim 8, which further contains:
a program for accomplishing a function of planning a timing for outputting said first information or said second information in such a fashion that a cumulative value obtained by adding said first index and said second index outputted in the past for a predetermined time to said first information the output of which is afresh requested does not exceed a threshold value set in advance.

10. A computer program product as defined in claim 8, which further contains:
a program for accomplishing a function of generating an overall output plan on the basis of the output plan of said first information by said virtual machine and the output plan of said second information inputted from said navigation portion, a function of calculating a cumulative value of said first index and said second index about said overall output plan, and a function of planning a timing for outputting said first information or said second information in such a fashion that said cumulative value does not exceed a threshold value set in advance.

11. A car-mounted terminal device comprising:
an application program portion for generating guide information by Internet information, etc;
a virtual machine portion for executing said application program;
a navigation portion including a road information database, a point information database, a route search portion and a route guide plan portion; and
an information output control portion for planning an output timing of first information outputted from said virtual machine portion and second information outputted from said route guide plan portion, and outputting said first information or said second information at said output timing.

12. A car-mounted terminal device as defined in claim 11, wherein said information output control portion comprises:
means for generating a first index representing said first information;
means for generating a second index representing said second information; and
means for planning a timing for outputting said first information or said second information on the basis of said first index and said second index.

13. A car-mounted terminal device as defined claim 12, wherein said information output control portion further comprises:
means for planning a timing for outputting said first information or said second information in such a fashion that a cumulative value obtained by adding said first index and said second index outputted in the past for a predetermined time to said first information the output of which is afresh requested does not exceed a threshold value set in advance.

14. A car-mounted terminal device as defined in claim 13, wherein said information output control portion further comprises:
means for changing said threshold value in accordance with a driving speed of a car.

15. A car-mounted terminal device as defined in claim 12, wherein said information output control portion further comprises:
means for generating an overall output plan on the basis of the output plan of said first information by said virtual machine and the output plan of said second information inputted from said navigation portion, means for calculating a cumulative value of said first index and said second index about said overall output plan, and means for planning a timing for outputting said first information or said second information in such a fashion that said cumulative value does not exceed a threshold value set in advance.

16. A car-mounted terminal device as defined in claim 15, wherein said information output control portion further comprises:
means for changing said threshold value in accordance with a driving speed of a car.

17. A car-mounted terminal device as defined in claim 12, which further comprises:
means for judging whether or not the output of said first information can be made when the timing for outputting said first information is planned, and means for again making said judgment after the output method of said first information is changed when the output of said first information is not judged as being possible.

18. A car-mounted terminal device as defined in claim 12, which further comprises:
means for reporting the result of said plan about the output of said first information to said virtual machine, and means for canceling the output of said first information or means for updating said plan.
